(19) United States
(12) Patent Application Publication
(10) Pub. No.: US 2013/0090812 A1
(43) Pub. Date: Apr. 11, 2013

(54) METHOD AND APPARATUS FOR MITIGATING STEERING WHEEL SHAKE

(71) Applicant: Mando Corporation, Gyeonggi-do (KR)

(72) Inventor: Won Jong CHUN, Seoul (KR)

(73) Assignee: MANDO CORPORATION, Gyeonggi-do (KR)

(21) Appl. No.: 13/646,025

(22) Filed: Oct. 5, 2012

(30) Foreign Application Priority Data
Oct. 5, 2011 (KR) 10-2011-0101166

(51) Int. Cl. B62D 6/08

(52) U.S. Cl. 701/42

(57) ABSTRACT

The present invention relates to a technology of mitigating shaking of a steering wheel, and more particularly to a steering wheel shake mitigating method and a steering wheel shake mitigating apparatus by which shaking of the steering wheel is mitigated by generating a steering wheel shake mitigating signal using a torque signal.

### CROSS-REFERENCE TO RELATED APPLICATION

This application claims priority from and the benefit under 35 U.S.C. §119(a) of Korean Patent Application No. 10-2011-0101166, filed on Oct. 5, 2011, which is hereby incorporated by reference for all purposes as if fully set forth herein.

### BACKGROUND OF THE INVENTION

1. Field of the Invention

The present invention relates to a technology of mitigating shakes of a steering wheel, and more particularly, to a steering wheel shake mitigating method and a steering wheel shake mitigating apparatus by which shaking of the steering wheel is mitigated by generating a steering wheel shake mitigating signal using a torque signal, and applying it to control of a motor.

2. Description of the Prior Art

As generally known in the art, a steering wheel is shaken due to causes such as an unbalance of tires. This significantly degrades a steering control quality or a steering feeling of a driver, hampering a safe operation of a vehicle.

### SUMMARY OF THE INVENTION

Accordingly, the present invention has been made to solve the above-mentioned problems occurring in the prior art, and an object of the present invention is to provide a method and an apparatus for mitigating shaking of a steering wheel, which may be generated due to a cause, such as an unbalance of tires.

In order to accomplish this object, there is provided a steering wheel shake mitigating apparatus including: a torque signal input unit for receiving a torque signal; a steering wheel shake mitigating signal generating unit for passing the input torque signal through a first order filter to filter the input torque signal in the first order, differentiating the first order filtered torque signal in an n-th order (n≧2) to generate differential signals corresponding to the orders, combining signals obtained by multiplying the differential signals corresponding to the orders by corresponding gains, and passing the combined signals through a second order filter to filter the combined signals in the second order, and generating a steering wheel shake mitigating signal; and a motor control unit for controlling a motor based on the steering wheel shake mitigating signal.

In accordance with another aspect of the present invention, there is provided a steering wheel shake mitigating method by using a steering wheel shake mitigating apparatus, including the steps of: receiving a torque signal; passing the input torque signal through a first order filter to filter the input torque signal in the first order; differentiating the first order filtered torque signal in an n-th order (n≧2) to generate differential signals corresponding to the orders; combining the differential signals corresponding to the orders by corresponding gains; passing the combined signals through a second order filter to filter the combined signals, and generating a steering wheel shake mitigating signal; and controlling a motor based on the steering wheel shake mitigating signal.

As described above, the present invention provides a steering wheel shake mitigating method and a steering wheel shake mitigating apparatus by which shaking of a steering wheel generated due to a cause such as an unbalance of tires can be mitigated.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a steering wheel shake mitigating apparatus according to an embodiment of the present invention;

FIG. 2 is a detailed block diagram illustrating a steering wheel shake mitigating signal generating unit of the steering wheel shake mitigating apparatus according to the embodiment of the present invention; and

FIG. 3 is a flowchart illustrating a steering wheel shake mitigating method according to an embodiment of the present invention.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

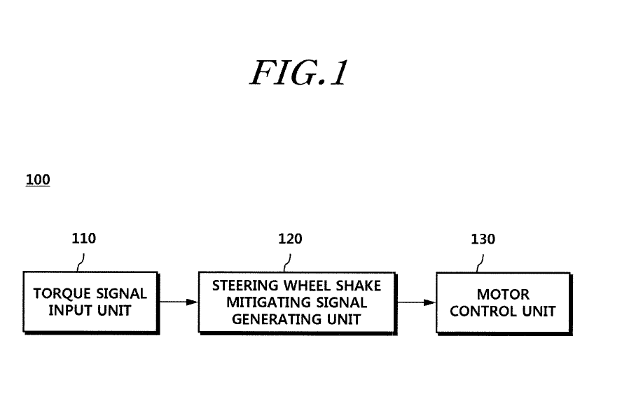

FIG. 1 is a block diagram illustrating a steering wheel shake mitigating apparatus 100 according to an embodiment of the present invention.

Referring to FIG. 1, the steering wheel shake mitigating apparatus 100 according to the embodiment of the present invention is an apparatus by which shaking of the steering wheel is mitigated by generating a steering wheel shake mitigating signal using a torque signal, and applying it to control of a motor.

The steering wheel shake mitigating apparatus 100 includes: a torque signal input unit 110 for receiving a torque signal from a torque sensor or the like; a steering wheel shake mitigating signal generating unit 120 for passing the input torque signal through a first order filter to filter the input torque signal in the first order, differentiating the first order filtered torque signal in an n-th order (n≧2) to generate differential signals corresponding to the orders, combining the differential signals corresponding to the orders by corresponding gains, and passing the combined signals through a second order filter to filter the combined signals in the second order, and generating a steering wheel shake mitigating signal; and a motor control unit 130 for controlling a motor based on the steering wheel shake mitigating signal.

For example, the first order filter may be a high pass filter (hereinafter, referred to as “HPF”) for filtering a steering wheel shake generating frequency band, and the second order filter may be a low pass filter (hereinafter, referred to as “LPF”) for filtering the steering wheel shake generating frequency band.

The shaking of the steering wheel which has been mentioned above may be shaking (also referred to as ‘vibrations’) transferred to the steering wheel due to an unbalance of tires, and are also called smooth road shake (SRS), shimmy, or the like.

A steering wheel often shows characteristics where shaking thereof is severely generated in a specific vibration frequency region. For example, the biggest vibrations may be generated in a column resonance frequency region of a vehicle. If a column resonance frequency is 15 Hz and a vehicle speed corresponding to a vibration frequency of 15 Hz is 60 MPH according to predefined vehicle speed/vibration frequency relationship information, the biggest vibrations may be generated around 15 Hz which is a column resonance frequency. The vibrations generated in this way correspond to shaking of the steering wheel, and the vicinity of the column resonance frequency (15 Hz) may be a steering wheel shake generating frequency band.

The steering wheel shake mitigating apparatus 100 according to the embodiment of the present invention may be applied to an electric power steering apparatus.

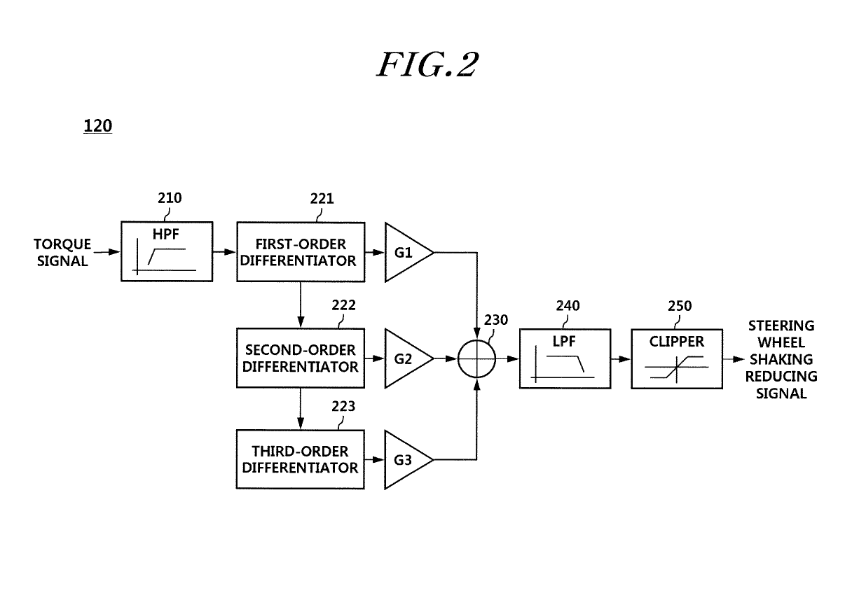

FIG. 2 is a detailed block diagram illustrating a steering wheel shake mitigating signal generating unit 120 of the steering wheel shake mitigating apparatus 100 according to the embodiment of the present invention. In FIG. 2, it is assumed that n is 3.

Referring to FIG. 2, the steering wheel shake mitigating signal generating unit 120 includes an HFP 210 for high-pass filtering (first order filtering) an input torque signal, a first order differentiator 221 for differentiating the high-pass filtered torque signal T in the first order and outputting the first order differential signal (dT/dt), a second order differentiator 222 for differentiating the first order differential signal (dT/dt) and outputting a second order differential signal (d²T/dt²), a third order differentiator 223 for differentiating the second order differential signal (d²T/dt²) and outputting a third order differential signal (d³T/dt³), an adder 230 for adding a value obtained by multiplying the first order differential signal (dT/dt) by a first gain (G1), a value obtained by multiplying the second order differential signal (d²T/dt²) by a second gain (G2), and a value obtained by multiplying the third order differential signal (d³T/dt³) by a third gain (G3), and an LPF 240 for low-pass filtering (second order filtering) the signal added by the adder 230.

The signal having passed through the LPF 240 has a current value, and the steering wheel shake mitigating signal generating unit 120 may further include a clipper 250 for clipping the current value based on a predefined maximum current value to use the clipped current value in control of a motor.

The current value clipped by the clipper 250 becomes a steering wheel shake mitigating signal which is a compensation signal for reducing shaking of a steering wheel, and may be supplied to the motor.

The above-mentioned first gain (G1), second gain (G2), and third gain (G3) may be defined by the vehicle speed.

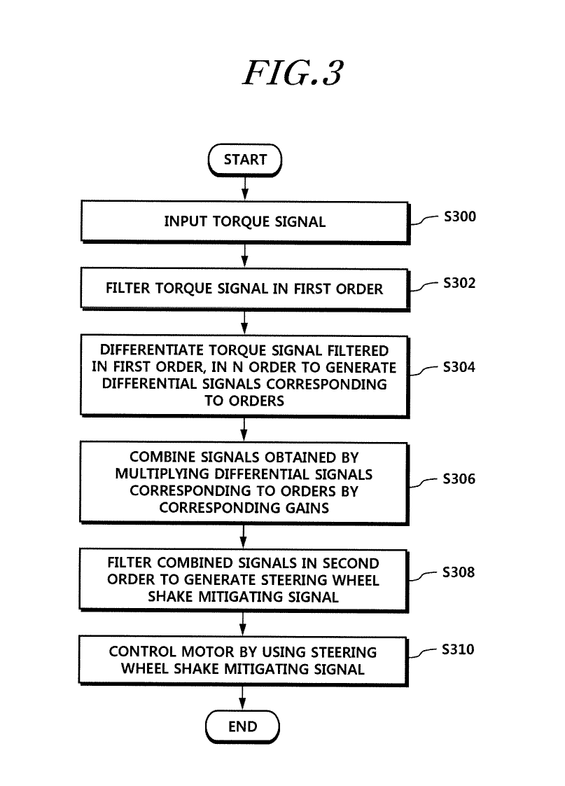

FIG. 3 is a flowchart illustrating a steering wheel shake mitigating method according to an embodiment of the present invention.

Referring to FIG. 3, the steering wheel shake mitigating method by using a steering wheel shake mitigating apparatus 100 according to the embodiment of the present invention includes the steps of: receiving a torque signal (S300); passing the input torque signal through a first order filter to filter the input torque signal in the first order (S302); differentiating the first order filtered torque signal in an n-th order (n2) to generate differential signals corresponding to the orders (S304); combining signals obtained by multiplying the differential signals corresponding to the orders by corresponding gains (S306); passing the combined signals through a second order filter to filter the combined signals in the second order, and generating a steering wheel shake mitigating signal (S308); and controlling a motor based on the steering wheel shake mitigating signal (S310).

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

The above description only pertains to an exemplary description of the technical spirit of the present invention, and may be variously modified and changed by those skilled in the art to which the present invention pertains without departing from the essential characteristics of the present invention. Thus, the embodiments disclosed in the present invention are not intended to limit the technical spirit of the present invention, and the range of the present invention is not limited to the embodiments. The protection range of the present invention shall be determined by the following claims, and all the technical spirits within the equivalent range shall be construed to fall within the scope of the present invention.

What is claimed is:

1. A steering wheel shake mitigating apparatus comprising:
a torque signal input unit for receiving a torque signal;
a steering wheel shake mitigating signal generating unit for passing the input torque signal through a first order filter to filter the input torque signal in the first order, differentiating the first order filtered torque signal in an n-th order (n≧2) to generate differential signals corresponding to the orders, combining signals obtained by multiplying the differential signals corresponding to the orders by corresponding gains, and passing the combined signals through a second order filter to filter the combined signals in the second order, and generating a steering wheel shake mitigating signal; and
a motor control unit for controlling a motor based on the steering wheel shake mitigating signal.

2. The steering wheel shake mitigating apparatus as claimed in claim 1, wherein the first order filter is a high pass filter for filtering a steering wheel shake generating frequency band, and the second order filter is a low pass filter for filtering the steering wheel shake generating frequency band.

3. The steering wheel shake mitigating apparatus as claimed in claim 1, wherein shaking of the steering wheel is vibrations transferred to the steering wheel due to an unbalance of tires.

4. A steering wheel shake mitigating method by using a steering wheel shake mitigating apparatus, comprising the steps of:
receiving a torque signal;
passing the input torque signal through a first order filter to filter the input torque signal in the first order;
differentiating the first order filtered torque signal in an n-th order (n≧2) to generate differential signals corresponding to the orders;
combining the differential signals corresponding to the orders by corresponding gains;
passing the combined signals through a second order filter to filter the combined signals in the second order, and generating a steering wheel shake mitigating signal; and
controlling a motor based on the steering wheel shake mitigating signal.
